(19) United States
(12) Patent Application Publication
(10) Pub. No.: US 2009/0052088 A1
(43) Pub. Date: Feb. 26, 2009

(54) Swaging process for actuator arm of hard disk drive

(75) Inventor: Edward Lim, Danville, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/894,870

(22) Filed: Aug. 21, 2007

(51) Int. Cl. G11B 5/48

(52) U.S. Cl. 360/244.7; 360/244.5

(57) ABSTRACT

A hard disk drive that includes an actuator arm assembly with an adhesive attached to an actuator arm and a head gimbal assembly swage openings of the arms. The adhesive can be attached to either head gimbal assembly or arm before they are joined together. The head gimbal assembly is then placed on the actuator arm: A swage ball is pushed through the openings to swage the head gimbal assembly to the actuator arm. The adhesive strengthens the attachment of the head gimbal assembly to the actuator arm. The increase in strength can further attenuate vibration that is transmitted into the actuator arm assembly.

### BACKGROUND OF THE INVENTION

1. Field of the Invention

The present invention relates to an actuator arm assembly of a hard disk drive.

2. Background Information

Hard disk drives contain a plurality of magnetic heads that are coupled to rotating disks. The heads can magnetize and sense the magnetic fields of the disk to write and read data, respectively. The heads are coupled to a pivoting actuator arm that has a voice coil motor.

Data is stored on concentric tracks across the surfaces of the drive. The voice coil motor can move the heads to different tracks. Each track typically contains servo information that is read and used by a servo routine of the drive to maintain the heads on the centers of the tracks.

The disks are rotated by a spindle motor. The rotation of the disks creates a flow of air within the disk drive. The flow of air cooperates with air bearing surfaces of the heads to create air bearings. The air bearings prevent or minimize contact and corresponding wear between the heads and the surfaces of the disks.

The flow of air can create vibration within the drive. Additionally, vibration can be caused by other factors internal or external to the drive. Vibration can cause unwanted movement of the heads. The vibration must either be attenuated, or compensated for by the servo of the disk drive. For example, the servo routine of the drive may have various feedback schemes to compensate for drive vibration to insure accurate placement of the heads relative to the disk surfaces.

To increase disk drive capacity it is desirable to increase the track per inch (“TPI”) density of the disks. TPI is dependent on track mis-registration (“TMR”) which is dependent on vibration among other factors. It would be desirable to improve the structure of a disk drive to reduce the head vibration, and allow for greater TPI and a resultant increase in the capacity of the disk drive.

### BRIEF SUMMARY OF THE INVENTION

An actuator arm assembly for a hard disk drive. The assembly includes an actuator arm attached to a head gimbal assembly. An adhesive is attached to the actuator arm and the head gimbal assembly adjacent to swage openings of the arms.

### BRIEF DESCRIPTION OF THE DRAWINGS

FIG. 1 is a top view of an embodiment of a hard disk drive;

FIG. 2 is a top view of an actuator arm assembly that includes an actuator arm and a separate head gimbal assembly;

FIG. 3 is a side view of a double sided adhesive;

FIG. 4 is a top view showing the head gimbal assembly attached to the actuator arm.

### DETAILED DESCRIPTION

Disclosed is a hard disk drive that includes an actuator arm assembly with an adhesive attached to an actuator arm and a head gimbal assembly, adjacent swage openings of the arms. The adhesive can be attached to either arm before the arms are joined together. The head gimbal assembly is then placed on the actuator arm. A swage ball is pushed through the openings to swage the head gimbal assembly to the actuator arm. The adhesive strengthens the attachment of the head gimbal assembly to the actuator arm. The increase in strength can further attenuate vibration that is transmitted into the actuator arm assembly.

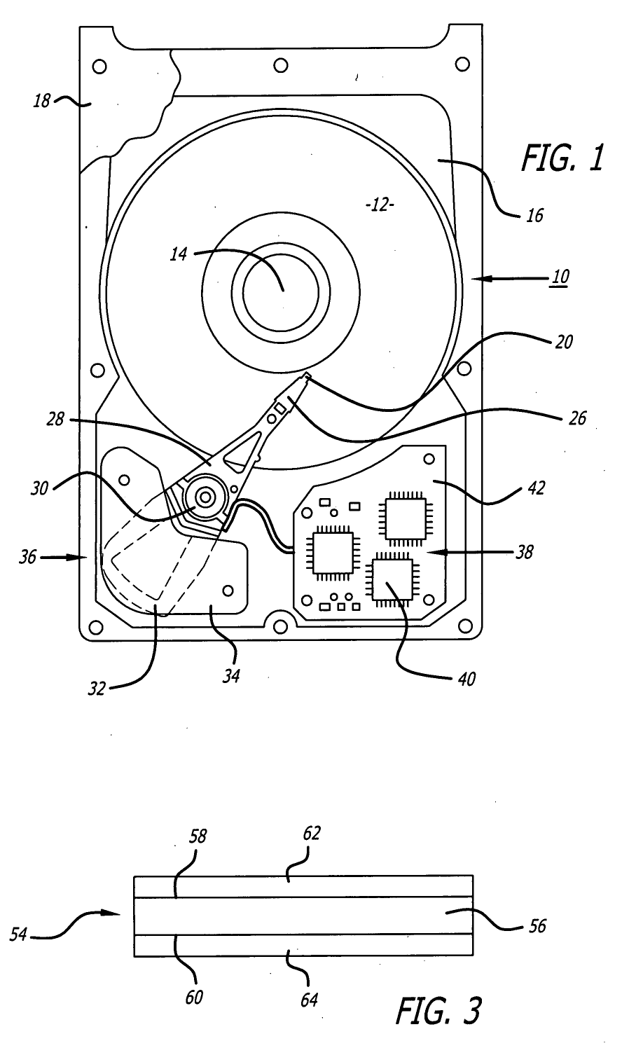

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

During operation of the disk drive 10 the spindle motor 14 rotates the disks 12. The rotation of the disks 12 creates a flow of air within the drive.

The disk drive 10 may include a plurality of heads 20 located adjacent to the disks 12. Each head 20 may have separate write (not shown) and read elements (not shown). The heads 20 are gimbal mounted to a suspension that together form a head gimbal assembly (head gimbal assembly). The head gimbal assembly 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

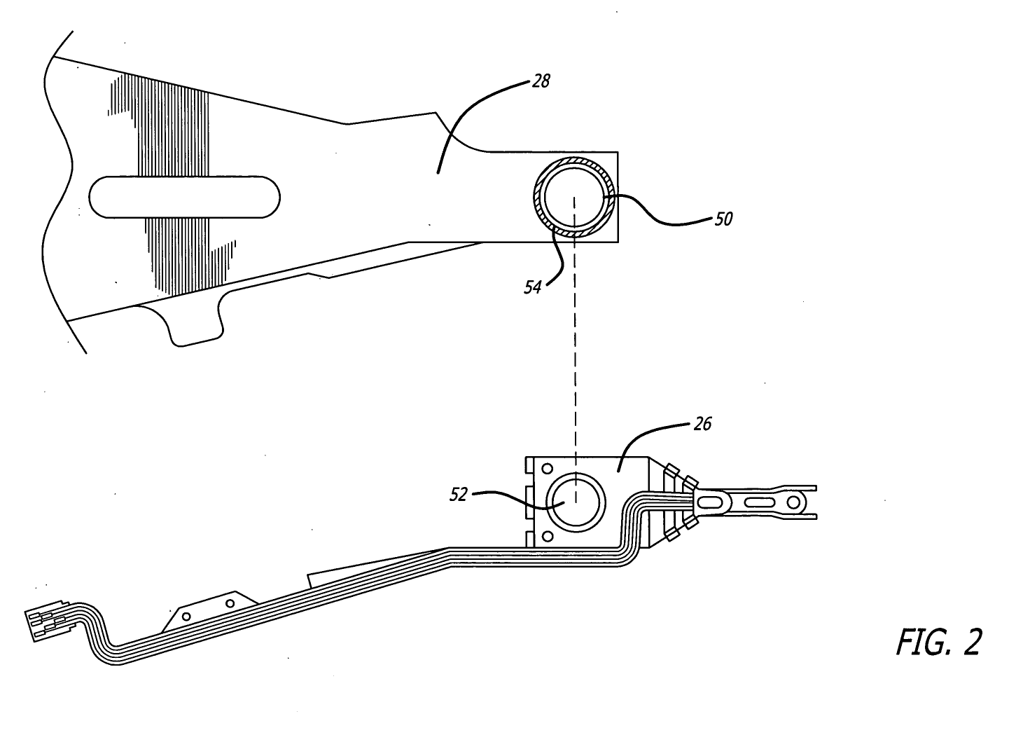

FIG. 2 shows an actuator arm 28 that has an actuator arm swage opening 50. FIG. 2 also shows the head gimbal assembly 26 before assembly to the actuator arm 28. The head gimbal assembly 26 has a head gimbal assembly opening 52. Adjacent to the actuator arm opening 50 is an adhesive 54. The adhesive 54 may have an annular ring shape that is approximately concentric with the opening 50.

FIG. 3 shows an embodiment of the adhesive 54. The adhesive 54 may include a layer of non-adhesive material 56 that has a first side 58 and a second side 60. A first layer of adhesive 62 may be located on the first side of the non-adhesive layer 56 and a second layer of adhesive 64 may be located on the second side 60. By way of example, the double sided adhesive may be a product sold by 3M under the product designation 242F 02.

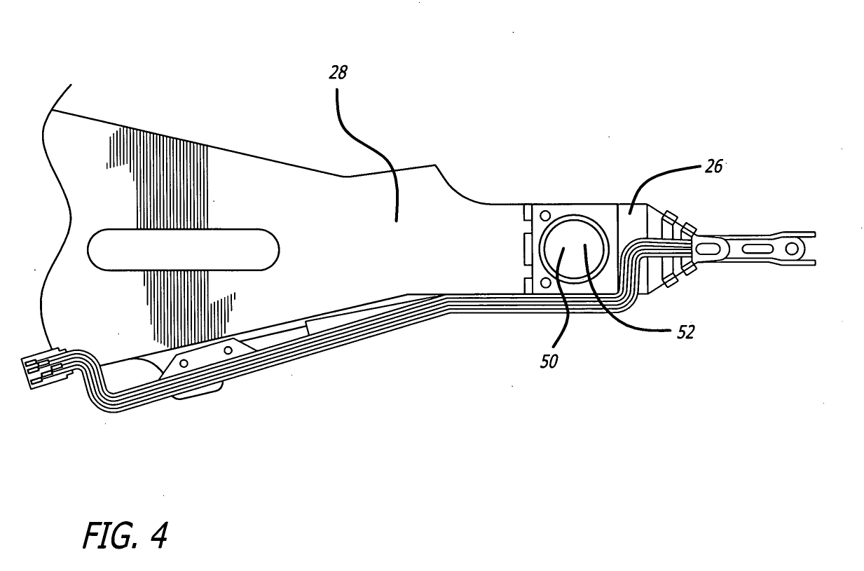

FIG. 4 shows the placement of the head gimbal assembly 26 onto the actuator arm 28. A swage ball (not shown) is then inserted through the openings 50 and 52 to swage the head gimbal assembly 26 to the actuator arm 28 as is known in the art.

The adhesive 54 is attached to both the actuator arm 28 and the head gimbal assembly 26 adjacent the swage openings 50 and 52. The adhesive 54 further strengthens the attachment of the head gimbal assembly 26 and 28. The increase in attachment strength can damp vibration that is transmitted through the arms 26 and 28. The increase in vibration damping improves head performance and may relax the requirements of the system servo required to compensate for vibration in the system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, the adhesive 54 may be attached to the head gimbal assembly 26 adjacent the head gimbal assembly opening 52 instead of attachment to the actuator arm 28 before the head gimbal assembly 26 and actuator arm 28 are joined together. Alternatively, adhesive 54 may be attached to both head gimbal assembly 26 and actuator arm 28 before they are joined together. Additionally, the adhesive 54 may be an epoxy. For example, the adhesive may be an Ecobond UV300X or ASEC-550LVUV-J.

What is claimed is:

1. An actuator arm assembly of a hard disk drive, comprising:
an actuator arm with an actuator arm swage opening;
a head gimbal assembly that has a head gimbal assembly swage opening; and,
an adhesive attached to said actuator arm and said head gimbal assembly is adjacent to said actuator arm and head gimbal assembly swage openings.

2. The arm assembly of claim 1, wherein said adhesive has an annular shape.

3. The arm assembly of claim 1, wherein said adhesive includes a layer of non-adhesive material that has a first side and a second side, and a first layer of adhesive on said first side and a second layer of adhesive on said second side.

4. The arm assembly of claim 1, wherein said adhesive includes an epoxy.

5. A hard disk drive, comprising:
a base plate;
a disk;
a spindle motor that is mounted to said base plate and rotates said disk;
a head coupled to said disk;
a head gimbal assembly that is coupled said head and has a head gimbal assembly swage opening;
an actuator arm that is coupled to said head gimbal assembly and has an actuator arm swage opening;
a voice coil motor coupled to said actuator arm;
an adhesive attached to said actuator arm and said head gimbal assembly adjacent to actuator arm and head gimbal assembly swage openings.

6. The disk drive of claim 5, wherein said adhesive has an annular shape.

7. The disk drive of claim 5, wherein said adhesive includes a layer of non-adhesive material that has a first side and a second side, and a first layer of adhesive on said first side and a second layer of adhesive on said second side.

8. The disk drive of claim 5, wherein said adhesive includes an epoxy.

9. A method for assembling a head gimbal assembly to an actuator arm of a hard disk drive, comprising:
attaching an adhesive to an actuator arm adjacent to an actuator arm swage opening;
placing a head gimbal assembly onto the actuator arm such that the adhesive is adjacent to a head gimbal assembly swage opening; and,
swaging the head gimbal assembly to the actuator arm.

10. The method of claim 8, wherein the adhesive is placed on the head gimbal assembly instead of the actuator arm before placing the head gimbal assembly onto the actuator arm.

11. The method of claim 8, wherein the adhesive includes a layer of non-adhesive material that has a first side and a second side, and a first layer of adhesive on the first side that adheres to the actuator arm and a second layer of adhesive on the second side that adheres to the head gimbal assembly.

12. The method of claim 8, wherein the adhesive has an annular shape.
